(19) United States
(12) Patent Application Publication
(10) Pub. No.: US 2026/0237666 A1
(43) Pub. Date: Aug. 13, 2026

(54) SOLID-STATE BATTERY AND MANUFACTURING METHOD OF SOLID-STATE BATTERY

(71) Applicant: TOYOTA JIDOSHA KABUSHIKI KAISHA, Toyota-shi (JP)

(72) Inventors: Kenichi KAKISHITA, Nagoya-shi (JP); Hideyuki Tokioka, Toyota-shi (JP); Takuya Kimura, Toyota-shi (JP); Tetsuya Waseda, Toyota-shi (JP); Takuya Matsuyama, Miyoshi-shi (JP); Yuki Sato, Nagakute-shi (JP)

(73) Assignee: TOYOTA JIDOSHA KABUSHIKI KAISHA, Toyota-shi (JP)

(21) Appl. No.: 19/402,309

(22) Filed: Nov. 26, 2025

(30) Foreign Application Priority Data
Feb. 7, 2025 (JP) 2025-019491

(51) Int. Cl. H01M 4/62; H01M 10/0562; H01M 10/0585

(52) U.S. Cl. CPC H01M 4/62; H01M 10/0562; H01M 10/0585

(57) ABSTRACT

A solid-state battery includes a current collector, an electrode active material layer disposed on at least one principal face of the current collector, an insulating layer disposed on the one principal face of the current collector so as to be in contact with an end portion of the electrode active material layer, and a solid electrolyte layer disposed on the electrode active material layer and the insulating layer, in which a Young's modulus of the insulating layer is smaller than a Young's modulus of the electrode active material layer.

### CROSS-REFERENCE TO RELATED APPLICATION

This application claims priority to Japanese Patent Application No. 2025-019491 filed on February 7, 2025. The disclosure of the above-identified application, including the specification, drawings, and claims, is incorporated by reference herein in its entirety.

### BACKGROUND

### 1. Technical Field

The present disclosure relates to a solid-state battery and a manufacturing method of the solid-state battery.

### 2. Description of Related Art

In recent years, secondary batteries have become increasingly important, and in addition to secondary batteries containing electrolytic solutions, development of solid-state batteries using solid electrolytes is underway. All-solid-state batteries, which are an example of solid-state batteries, are batteries that have a solid electrolyte layer instead of an electrolytic solution, and safety devices can be simplified since flammable organic solvents are not used, and manufacturing costs and productivity thereof are excellent.

Japanese Unexamined Patent Application Publication No. 2024-025996 (JP 2024-025996 A) discloses a solid-state battery including a laminate in which a cathode layer, an anode layer, and a solid electrolyte layer are laminated. In the solid-state battery disclosed in JP 2024-025996 A, a cathode active material layer and a margin layer (layer made of insulating material) in contact with the cathode active material layer are formed on both principal faces of a cathode current collector. In the solid-state battery disclosed in JP 2024-025996 A, the margin layer in contact with the cathode active material layer has a distribution in the Young's modulus in an in-plane direction. Thus, according to JP 2024-025996 A, stress concentration at the boundary between the margin layer and the cathode active material layer can be mitigated, mechanical strength of the laminate can be improved, and deterioration such as cracking, peeling, and so forth, inside the laminate, can be effectively suppressed.

Also, Japanese Unexamined Patent Application Publication No. 2023-107428 (JP 2023-107428 A) discloses a solid-state battery in which a cathode layer formed on a cathode current collector has an inclined face that inclines toward the cathode current collector, and this inclined face is covered with an ion conductor layer that has a lower Young's modulus than that of a solid electrolyte layer. According to JP 2023-107428 A, even when the cathode layer expands and contracts due to charging and discharging, stress concentration on the solid electrolyte layer at corners of the cathode layer can be suppressed.

### SUMMARY

However, when pressure is applied in a laminating direction to a structure in which an electrode active material layer is laminated on a current collector and an insulating layer is laminated so as to be in contact with this electrode active material layer, or the like, there is a concern that the insulating layer may be damaged. Accordingly, an object of one embodiment of the present disclosure is to provide a solid-state battery and a method for manufacturing the solid-state battery that can suppress damage to an insulating layer even when pressure is applied in the laminating direction to a structure in which an electrode active material layer is laminated on a current collector and the insulating layer is laminated so as to be in contact with this electrode active material layer.

The present disclosure that achieves the above object encompasses the following aspects.

<1> A solid-state battery includes a current collector, an electrode active material layer disposed on at least one principal face of the current collector,

an insulating layer disposed on the one principal face of the current collector so as to be in contact with an end portion of the electrode active material layer, and a solid electrolyte layer disposed on the electrode active material layer and the insulating layer, in which a Young's modulus of the insulating layer is smaller than a Young's modulus of the electrode active material layer.

<2> The solid-state battery according to <1>, in which a value obtained by dividing the Young's modulus of the electrode active material layer by the Young's modulus of the insulating layer is in a range of 1.1 to 2.0.

<3> The solid-state battery according to <1> or <2>, wherein the insulating layer includes a filler.

<4> A manufacturing method of a solid-state battery includes fashioning, on at least one principal face of a current collector, an electrode active material layer, and an insulating layer so as to be in contact with an end portion of the electrode active material layer, pressurizing the current collector, the electrode active material layer, and the insulating layer, in a laminating direction, and fashioning a solid electrolyte layer on the electrode active material layer and the insulating layer, in which a Young's modulus of the insulating layer is smaller than a Young's modulus of the electrode active material layer.

<5> The manufacturing method according to <4>, in which a value obtained by dividing the Young's modulus of the electrode active material layer by the Young's modulus of the insulating layer is in a range of 1.1 to 2.0.

<6> The manufacturing method according to <4> or <5>, in which the insulating layer includes a filler.

According to one embodiment of the present disclosure, damage to the insulating layer can be suppressed even when pressure is applied in the laminating direction to a structure in which the electrode active material layer is laminated on the current collector and the insulating layer is laminated so as to be in contact with the electrode active material layer.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a principal-portion cross-sectional view of a solid-state battery according to an embodiment of the present disclosure; and

FIG. 2 is a schematic plan view illustrating an example of a position where a surface of the solid-state battery is cut along a plane parallel to a first axis direction, in plan view from above.

### DETAILED DESCRIPTION OF EMBODIMENTS

In the present disclosure, numerical value ranges that are indicated using "to" indicate a range that includes numerical values written before and after the "to" as the minimum value and the maximum value, respectively.

In the present disclosure, in which numerical value ranges are described in stages, an upper limit value or a lower limit value that is described in a certain numerical value range may be replaced with an upper limit value or a lower limit value of another numerical value range that is described in stages. In the numerical ranges described in the present disclosure, the upper limit value or the lower limit value that is described in a certain numerical value range may be replaced with a value indicated in the examples.

In the present disclosure, the term "process" includes not only independent processes but also processes that may not be clearly distinguishable from other processes, as long as the intended purpose of the process is achieved. In the present disclosure, when there is a plurality of types of substances corresponding to each component, the amount of each component means the total amount of the substances of the multiple types, unless otherwise specified.

In the present disclosure, when an embodiment is described with reference to drawings, the configuration of the embodiment is not limited to the configuration that is illustrated in the drawings. Also, the sizes of the members in the drawings are conceptual, and relative relations between the sizes of the members are not limited to these.

### Solid-State Battery

A solid-state battery of the present disclosure will be described below. The solid-state battery according to the present disclosure includes a current collector, an electrode active material layer disposed on at least one principal face of the current collector, an insulating layer disposed on the one principal face of the current collector so as to be in contact with an end portion of the electrode active material layer, and a solid electrolyte layer disposed on the electrode active material layer and the insulating layer, in which a Young's modulus of the insulating layer is smaller than a Young's modulus of the electrode active material layer. In the solid-state battery according to the present disclosure, even when pressure is applied in a laminating direction to the electrode active material layer and the insulating layer that are laminated on the current collector (e.g., in a constrained state in which the current collector, electrode layer, and so forth are pressurized into close contact, under external force applied in the laminating direction), damage to the insulating layer can be suppressed. Also, in the solid-state battery according to the present disclosure, when pressure is applied in the laminating direction as described above, a stepped formation between the electrode active material layer and the insulating layer that are disposed on the current collector is resolved, and the solid electrolyte layer can be suitably made to be in close contact with the electrode active material layer and the insulating layer.

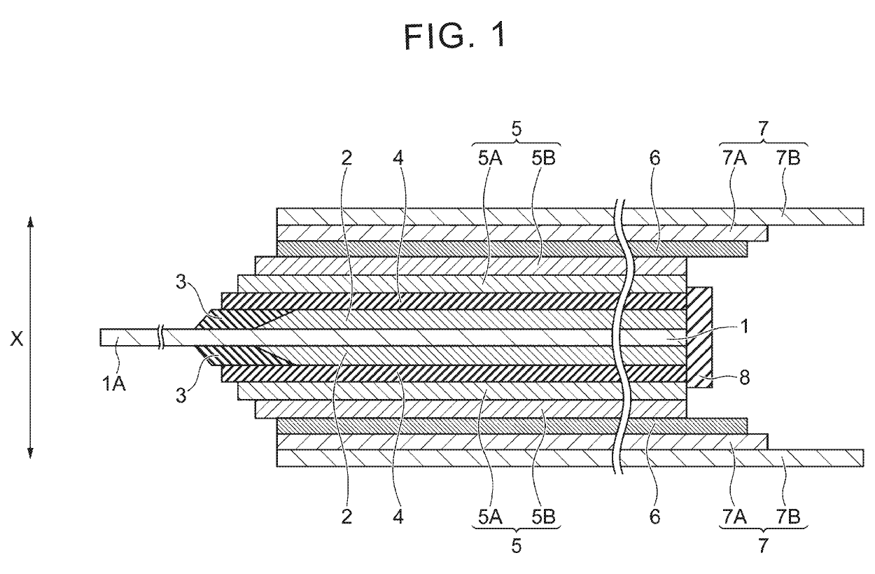

As illustrated in FIG. 1, a solid-state battery illustrated as an embodiment of the present disclosure includes a cathode current collector 1, cathode layers 2 and insulating layers 3 that are disposed on both principal faces of the cathode current collector 1, solid electrolyte layers 4 that are disposed on the cathode layers 2 and the insulating layers 3, anode layers 5 that are disposed on the solid electrolyte layers 4, carbon coating layers 6 that are disposed on the anode layers 5, and anode current collectors 7 that are disposed on the carbon coating layers 6. Note that in the solid-state battery illustrated in FIG. 1, a configuration is made in which the cathode layers 2 and the insulating layers 3 are disposed on both principal faces of the cathode current collector 1, but the solid-state battery according to the present disclosure is not limited to this configuration. For example, the solid-state battery of the present disclosure may have a configuration in which the cathode layer 2 and the insulating layer 3 are disposed on one principal face of the cathode current collector 1. Also, the solid-state battery of the present disclosure may have a configuration in which the anode layer and the insulating layer are disposed on both principal faces or one principal face of the anode current collector, the solid electrolyte layer is disposed on the anode layer and the insulating layer, and the cathode layer and the cathode current collector are disposed on the solid electrolyte layer. That is to say, in the solid-state battery according to the present disclosure, the current collector and the electrode active material layer refer to either a case of being the cathode current collector and the cathode layer, and a case of being the anode current collector and the anode layer.

Also, in the solid-state battery illustrated in FIG. 1, the cathode current collector 1 has a cathode current collector tab side end portion 1A that is connected to a cathode current collector tab. The insulating layers 3 and the cathode layers 2 are disposed in this order from the cathode current collector tab side end portion 1A. The solid-state battery illustrated in FIG. 1 is provided with an end-portion insulator 8 at an end portion of the cathode current collector 1 opposite to the cathode current collector tab side end portion 1A. Note that in the present disclosure, the term “laminating direction” means the direction in which the cathode current collector 1, the cathode layers 2, the solid electrolyte layers 4, and so forth, are laminated, as indicated by an arrow X in FIG. 1.

In the solid-state battery illustrated in FIG. 1, the anode layers 5 are each divided into two layers, which are a first anode layer 5A that is situated on the solid electrolyte layer 4, and a second anode layer 5B that is situated on the first anode layer 5A. Note, however, that the anode layers 5 may each be a single layer, or may have two or more sub-layers. Also, in the solid-state battery illustrated in FIG. 1, the anode current collectors 7 are each divided into two layers, which are a first anode current collector 7A that is situated on the anode layer 5, and a second anode current collector 7B that is situated on the first anode current collector 7A. Note, however, that the anode current collectors 7 may each be a single layer, or may have two or more sub-layers.

In the solid-state battery illustrated in FIG. 1, the cathode layers 2 and the insulating layers 3 are formed flush with the principal faces of the cathode current collector 1. That is to say, the cathode layers 2 and the insulating layers 3 are in contact with each other at one end face, with the principal faces of the cathode layers 2 and the principal faces of the insulating layers 3 making up same planes. In the solid-state battery according to the present disclosure, the Young's modulus of the insulating layers 3 is smaller than the Young's modulus of the cathode layers 2, and accordingly, applying pressure in the laminating direction in a state in which the cathode layers 2 and the insulating layers 3 that are disposed on the principal faces of the cathode current collector 1 enables stepped formations between the principal faces of the cathode layers 2 and the principal faces of the insulating layers 3 to be resolved, so as to make up same planes. Also, in the solid-state battery illustrated in FIG. 1, end portions of the solid electrolyte layers 4 on the cathode current collector tab side end portion 1A side thereof are positioned overlapping the insulating layer 3. In other words, the end portions of the solid electrolyte layers 4 on the cathode current collector tab side end portion 1A side thereof are positioned not overlapping the cathode layers 2, and the solid electrolyte layers 4 are formed covering the entire faces of the cathode layers 2.

Also, in the solid-state battery illustrated in FIG. 1, the cathode layers 2 are formed by applying a cathode slurry to the principal faces of the cathode current collector 1 and performing drying thereof. Accordingly, end faces of the cathode layers 2 on the cathode current collector tab side end portion 1A side thereof becomes inclined faces due to running. Note that the end faces of the cathode layers 2 opposite to the cathode current collector tab side end portion 1A side are cut, and accordingly are not inclined faces but are faces approximately parallel to the laminating direction. Also, in the solid-state battery illustrated in FIG. 1, the insulating layers 3 are formed by applying an insulating slurry containing an insulating material and performing drying thereof, after the cathode layers 2 having the inclined faces are formed. Accordingly, end faces of the insulating layers 3 on the cathode current collector tab side end portion 1A side thereof become inclined faces due to running.

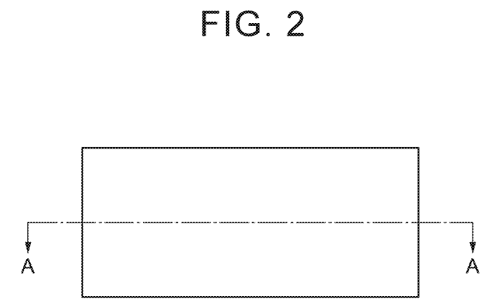

Also, in the solid-state battery illustrated in FIG. 1, the end portions of the solid electrolyte layers 4 on the cathode current collector tab side end portion 1A side thereof are positioned overlapping the insulating layers 3 in a cross-sectional view taken along the laminating direction X of the cathode current collector 1, the cathode layers 2, and the insulating layers 3. The term “cross-sectional view taken along the laminating direction X” refers to a cross-section of the solid-state battery taken along the laminating direction X of the battery laminate structure being viewed, and in particular refers to a cross-section passing through the cathode current collector tab side end portion 1A and the end portion opposite to the cathode current collector tab side end portion 1A being viewed. More specifically, when the solid-state battery illustrated in FIG. 1 is a prismatic battery, the cross-sectional view along the laminating direction X can be a cross-sectional view of a cross-section taken along line A-A that divides a short side direction of a rectangle into two approximately equal parts, as viewed in plan view from above, as illustrated in FIG. 2. Note that in FIG. 2, the line A-A that divides the rectangular shape in the short side direction into two approximately equal parts passes through the cathode current collector tab side end portion 1A and the end-portion insulator 8.

In the solid-state battery configured as described above, the Young's modulus of the insulating layers 3 is smaller than the Young's modulus of the cathode layers 2. Accordingly, even when pressure is applied to the solid-state battery in the laminating direction X, damage to the insulating layers 3, particularly damage near the end faces of the insulating layers 3 and damage to boundary portions of the insulating layers 3 with the cathode layers 2, can be suppressed. Now, an example of applying pressure in the laminating direction X includes a process in which the cathode layers 2 and the insulating layers 3 are disposed on the principal faces of the cathode current collector 1, and then the cathode layers 2 are compressed in the laminating direction X to densify the cathode layers. In this case, the Young's modulus of the insulating layers 3 is smaller than the Young's modulus of the cathode layers 2, and accordingly damage to the insulating layers 3, particularly damage near the end faces of the insulating layers 3 and damage to the boundary portions of the insulating layers 3 with the cathode layers 2, can be suppressed, and also stepped formations between the cathode layers 2 and the insulating layers 3 can be resolved, so as to make up same planes.

Also, in the solid-state battery illustrated in FIG. 1, the cathode current collector 1, the cathode layers 2, the insulating layers 3, and the solid electrolyte layers 4 may be laminated in this order, and then pressure may be applied in a direction in which the cathode current collector 1, the cathode layers 2, the insulating layers 3, and the solid electrolyte layer 4 are sandwiched, thereby densifying the cathode layers 2 and also bringing the solid electrolyte layers 4 into close contact with the cathode layers 2. In this case as well, the Young's modulus of the insulating layers 3 is smaller than the Young's modulus of the cathode layers 2, and accordingly damage to the insulating layers 3, particularly damage near the end faces of the insulating layers 3 and damage to the boundary portions of the insulating layers 3 with the cathode layers 2, can be suppressed.

Furthermore, the solid-state battery may further include a constraining member for constraining the solid-state battery in the laminating direction X, although omitted from illustration. The constraining member applies constraining pressure to the electrode laminate described above, in the laminating direction X. Even when the above-described constraining pressure is applied by the constraining member, damage to the insulating layers 3, particularly damage near the end faces of the insulating layers 3 and damage to the boundary portions of the insulating layers 3 with the cathode layers 2, can be suppressed in the solid-state battery according to the present disclosure.

Here, in the solid-state battery according to the present disclosure, a value obtained by dividing the Young's modulus of the electrode active material layer by the Young's modulus of the insulating layer is preferably in a range of 1.1 to 2.0. That is to say, in the solid-state battery illustrated in FIG. 1, the value obtained by dividing the Young's modulus of the cathode layer 2 by the Young's modulus of the insulating layer 3 is preferably in the range of 1.1 to 2.0. Setting the value obtained by dividing the Young's modulus of the cathode layer 2 by the Young's modulus of the insulating layer 3 to be 1.1 or more enables damage to the insulating layers 3, particularly damage near the end faces of the insulating layers 3 and damage to the boundary portions of the insulating layers 3 with the cathode layers 2, to be more reliably suppressed. Also, setting the value obtained by dividing the Young's modulus of the cathode layer 2 by the Young's modulus of the insulating layer 3 to 2.0 or less enables the solid electrolyte layers 4 disposed on the insulating layers 3 to be supported in a sure manner. Note that the Young's moduli of the insulating layers 3, the electrode active material layers, and so forth, can be measured conforming to JIS G0567 for a tensile test method, which is a type of stationary test method.

### Components of Solid-State Battery

### Cathode Current Collector

The cathode current collector to be employed can be any commonly used cathode current collector for batteries. The cathode current collector may be in the form of foil, a plate, mesh, perforated metal, foam, or the like. The cathode current collector may be made of metal foil or metal mesh. In particular, metal foil is excellent in terms of ease of handling. The cathode current collector may be made of a plurality of sheets of foil. Examples of metals that may be used for the cathode current collector include copper (Cu), nickel (Ni), chromium (Cr), gold (Au), platinum (Pt), silver (Ag), aluminum (Al), iron (Fe), titanium (Ti), zinc (Zn), cobalt (Co), stainless steel, and so forth. In particular, the cathode current collector may contain Al, from the perspective of ensuring oxidation resistance, and so forth.

### Cathode Layer

The cathode layer contains at least a cathode active material, and may further optionally contain an electrolyte, an electrically conductive aid, a binder, and so forth. The cathode layer may further contain various types of additives. The cathode active material can be any known material that is used as a cathode active material for secondary batteries. Examples of the cathode active material may include at least one selected from various types of lithium-containing compounds, elemental sulfur, sulfur compounds, and the like. The lithium-containing compound serving as a cathode active material may be any of various types of lithium-containing oxides, such as lithium cobaltate, lithium nickelate, Li_{1±α}Ni_{1/3}Co_{1/3}Mn_{1/3}O_{2±δ}, lithium manganate, spinel-based lithium compounds (such as Li-Mn spinel or the like substituted with different elements having a composition that is expressed as Li₁₊ₓMn_{2-x-y}M_{y}O₄ (where M is one or more selected from Al, Mg, Co, Fe, Ni, and Zn)), lithium titanate, lithium metal phosphate (such as LiMPO₄ or the like, where M is one or more selected from Fe, Mn, Co, and Ni), and so forth.

### Insulating Layer

The insulating layer is not limited in particular and may have any composition as long as it is not electrically conductive. For example, the insulating layer can include a filler, such as an inorganic filler or the like, and a binder. In a case of the insulating layer having a filler, an anchor effect can be exhibited with respect to the solid electrolyte layer disposed on the insulating layer, and the insulating layer and the solid electrolyte layer can be more strongly bonded to each other. Examples of inorganic fillers include inorganic materials such as silica like spherical silica, crystalline silica, and so forth, glass, alumina, calcium carbonate, zirconium silicate, calcium silicate, silicon nitride, aluminum nitride, boron nitride, beryllia, zirconia, zircon, fosterite, steatite, spinel, mullite, titania, talc, clay, mica, and so forth. As an example, the insulating layer may be a composition including alumina and a binder. The amount of filler contained in the insulating layer is not limited in particular, and can be, for example, 1% by volume to 10% by volume, preferably 3% by volume to 10% by volume, and more preferably 5% by volume to 10% by volume. Setting the amount of filler contained in the insulating layer within this range enables the aforementioned anchor effect to be exhibited more strongly.

The Young's modulus of the insulating layer can be adjusted as appropriate by adjusting, for example, the type of filler, the filler content, the type of binder, the binder content, other additives, and so forth. This enables the Young's modulus of the insulating layer to be made to be smaller than the Young's modulus of the electrode active material layer (cathode layer or anode layer). This also enables setting the value obtained by dividing the Young's modulus of the electrode active material layer (cathode layer or anode layer) by the Young's modulus of the insulating layer to be in the range of 1.1 to 2.0.

### Solid Electrolyte Layer

Examples of the solid electrolyte layer include electrolyte layers used in semi-solid-state batteries and all-solid-state batteries. The thickness of the solid electrolyte layer is not limited in particular, and can be selected from a range of 1 μm to 30 μm, for example. The type of solid electrolyte contained in the solid electrolyte layer is not limited in particular. For example, a solid electrolyte selected from those described above as being usable in the electrode layers may be used. The solid electrolyte layer may be a single layer or may be a multilayer structure including two or more layers.

When including a solid electrolyte, the solid-state battery according to the present disclosure may further include, along with the solid electrolyte, an electrolytic solution in an amount of less than 10% by mass with respect to the total mass of the electrolyte. When the battery according to the present disclosure includes a solid electrolyte, the solid electrolyte may be a composite solid electrolyte containing both an inorganic solid electrolyte and a polymer-based electrolyte. The solid electrolyte preferably contains at least one solid electrolyte type selected from a group of solid electrolytes consisting of sulfide solid electrolytes, oxide solid electrolytes, and halide solid electrolytes. When the solid-state battery of the present disclosure includes an electrolytic solution as an electrolyte, the type of the electrolytic solution is not limited in particular, and any known electrolytic solution can be used. Specific examples of the electrolytic solution include liquids obtained by dissolving a lithium salt such as LiPF₆, LiFSI, or the like, in an organic solvent.

### Anode Layer

The anode layer contains at least an anode active material, and may further optionally contain an electrolyte, an electrically conductive aid, a binder, and the like. The anode layer may further contain various types of other additives. Examples of the anode active material include carbon materials, active materials containing elemental silicon (Si), metallic lithium, lithium-containing alloys, metals or alloys capable of forming alloys with lithium, oxides, transition metal nitrides, and so forth. Examples of the carbon material include graphite materials, amorphous carbon materials, carbon black, activated carbon, and so forth. Examples of active materials containing elemental Si include pure silicon, silicon alloys (e.g., alloys of Si and one or more metals selected from a group consisting of Sn, Ti, Fe, Ni, Cu, Co, and Al), porous silicon, silicon clathrate compounds, silicon oxides, and so forth.

### Anode Current Collector

Any commonly used anode current collector for batteries can be employed as the anode current collector. Also, the anode current collector may be in the form of foil, a plate, mesh, perforated metal, foam, or the like. The anode current collector may be a metal foil or metal mesh, or may be a carbon sheet. The anode current collector may be made of a plurality of foils or sheets. Examples of metals from which the anode current collector may be made include Cu, Ni, Cr, Au, Pt, Ag, Al, Fe, Ti, Zn, Co, stainless steel, and so forth. In particular, from the perspective of ensuring resistance to reduction, and being less likely to be alloyed with lithium, the anode current collector may contain at least one metal selected from Cu, Ni, and stainless steel.

### Carbon Coating Layer

The carbon coating layer functions as an adhesive layer for joining the above-described anode current collector to the anode layer, and also functions as a conductive layer for ensuring electrical conductivity between the anode current collector and the anode layer. Examples of the carbon material contained in the carbon coating layer include graphite materials, amorphous carbon materials, carbon black, activated carbon, and so forth.

### Constraining Member

The solid-state battery of the present disclosure may further include the constraining member. The constraining member applies constraining pressure to the above-described electrode laminate in a thickness direction. The constraining pressure applied in the thickness direction of the electrode laminate may be, for example, 0.1 MPa or more, 1 MPa or more, or 5 MPa or more. The constraining pressure applied in the thickness direction of the electrode laminate may be, for example, 100 MPa or less, 50 MPa or less, or 20 MPa or less.

### Manufacturing Method of Solid-State Battery

A manufacturing method of the solid-state battery of the present disclosure includes the processes of fashioning, on at least one principal face of a current collector, an electrode active material layer, and an insulating layer so as to be in contact with an end portion of the electrode active material layer, pressurizing the current collector, the electrode active material layer, and the insulating layer, in a laminating direction, and fashioning a solid electrolyte layer on the electrode active material layer and the insulating layer. In the manufacturing method of the solid-state battery according to the present disclosure, the Young's modulus of the insulating layer is smaller than the Young's modulus of the electrode active material layer, and accordingly damage to the insulating layer can be suppressed even through the process of pressurizing. Also, in the manufacturing method of the solid-state battery according to the present disclosure, performing the process of pressurizing resolves any stepped formation between the electrode active material layer and the insulating layer that are disposed on the current collector, and the solid electrolyte layer can be suitably adhered to the electrode active material layer and the insulating layer. Note that in the manufacturing method of the solid-state battery according to the present disclosure, the electrode active material layer can be densified by the process of applying pressure in the laminating direction of the current collector, the electrode active material layer, and the insulating layer.

Also, in the manufacturing method of the solid-state battery according to the present disclosure, in the process of forming the solid electrolyte layer on the electrode active material layer and the insulating layer, pressurization may be performed in the laminating direction of the current collector, the electrode active material layer, the insulating layer, and the solid electrolyte layer. Applying pressure in the laminating direction of the current collector, the electrode active material layer, the insulating layer, and the solid electrolyte layer enables the solid electrolyte layer to be firmly brought into close contact with the electrode active material layer and the insulating layer. In this case as well, the Young's modulus of the insulating layer is smaller than the Young's modulus of the electrode active material layer, and accordingly damage to the insulating layer can be suppressed.

Regarding the manufacturing method of the solid-state battery according to the present disclosure, taking the solid-state battery illustrating in FIG. 1 as an example, first, the cathode layers 2 and the insulating layers 3 are formed on both principal faces of the cathode current collector 1. Thereafter, the solid electrolyte layers 4 are formed on the cathode layers 2 and the insulating layers 3 such that the end portions of the solid electrolyte layers overlap the insulating layers 3. The anode layers 5, the carbon coating layers 6, and the anode current collectors 7 are then sequentially formed on the solid electrolyte layers 4, whereby the solid-state battery illustrated in FIG. 1 can be manufactured. At this time, the cathode layers 2 and the insulating layers 3 are formed on both principal faces of the cathode current collector 1, and the pressurization is performed in the laminating direction X so as to sandwich the cathode current collector 1, thereby densifying the cathode layers 2 formed on both principal faces of the cathode current collector 1. This also resolves any stepped formations between the cathode layers 2 and the insulating layers 3, whereby the cathode layers 2 and the insulating layers 3 can make up same planes. Thereafter, the solid electrolyte layers 4 are formed on the cathode layers 2 and the insulating layers 3. Note that after the solid electrolyte layers 4 are formed, the cathode layers 2 and the solid electrolyte layers 4 can be densified at the same time by pressurizing thereof in the laminating direction X so as to sandwich the cathode current collector 1 therebetween.

Specifically, in the manufacturing method of the solid-state battery according to the present disclosure, the Young's modulus of the insulating layers 3 is smaller than the Young's modulus of the cathode layers 2, and accordingly stepped formations between the cathode layers 2 and the insulating layers 3 are resolved, and the cathode layers 2 and the insulating layers 3 are made to be same planes, and thus the solid electrolyte layers 4 can be brought into close contact with the cathode layers 2 and the insulating layers 3. It has been confirmed that when the principal faces of the cathode layers 2 are 10 μm lower than the principal faces of the insulating layers 3, the solid electrolyte layers 4 cannot be brought into close contact with the cathode layers 2. It has also been confirmed that when the principal faces of the cathode layers 2 are 10 μm higher than the principal faces of the insulating layers 3, the solid electrolyte layers 4 cannot be brought into close contact with the insulating layers 3. Accordingly, in the manufacturing method of the solid-state battery according to the present disclosure, pressurizing in the laminating direction X so as to sandwich the cathode current collector 1 makes the stepped formations between the cathode layers 2 and the insulating layers 3 to be less than 10 μm, preferably 5.0 μm or less, more preferably 3.0 μm or less, and even more preferably 1.0 μm or less.

Thereafter, the anode layers 5 are formed on the solid electrolyte layers 4. At this time, the anode layers 5 are formed such that the end portions of the anode layers 5 on the cathode current collector tab side end portions 1A side thereof are positioned overlapping the solid electrolyte layers 4 and the insulating layers 3. The carbon coating layers 6 in the laminate of the anode current collectors 7 and the carbon coating layers 6 are then bonded to the anode layers 5. Thus, the carbon coating layers 6 and the anode current collectors 7 can be formed on the anode layers 5.

According to the manufacturing method of the solid-state battery disclosed in the present disclosure, the Young's modulus of the insulating layers 3 is smaller than the Young's modulus of the cathode layers 2, and accordingly, even when the cathode current collector 1, the cathode layers 2, and the insulating layers 3 are pressurized in the laminating direction X to densify the cathode layers 2, damage to the insulating layers 3, particularly damage near the end faces of the insulating layers 3 and damage to the boundary portions of the insulating layers 3 with the cathode layers 2, can be suppressed. Furthermore, in the manufacturing method of the solid-state battery in the present disclosure, even when the solid electrolyte layers 4 are formed on the cathode layers 2 and the insulating layers 3 and then compressed in the laminating direction X so as to sandwich the cathode current collector 1, damage to the insulating layers 3, particularly damage near the end faces of the insulating layers 3 and damage to the boundary portions of the insulating layers 3 with the cathode layer 2, can be suppressed.

What is claimed is:

1. A solid-state battery comprising:
a current collector;
an electrode active material layer disposed on at least one principal face of the current collector;
an insulating layer disposed on the one principal face of the current collector so as to be in contact with an end portion of the electrode active material layer; and
a solid electrolyte layer disposed on the electrode active material layer and the insulating layer, wherein
a Young's modulus of the insulating layer is smaller than a Young's modulus of the electrode active material layer.

2. The solid-state battery according to claim 1, wherein a value obtained by dividing the Young's modulus of the electrode active material layer by the Young's modulus of the insulating layer is in a range of 1.1 to 2.0.

3. The solid-state battery according to claim 1, wherein the insulating layer includes a filler.

4. A manufacturing method of a solid-state battery, the manufacturing method comprising:
fashioning, on at least one principal face of a current collector, an electrode active material layer, and an insulating layer so as to be in contact with an end portion of the electrode active material layer;
pressurizing the current collector, the electrode active material layer, and the insulating layer, in a laminating direction; and
fashioning a solid electrolyte layer on the electrode active material layer and the insulating layer, wherein
a Young's modulus of the insulating layer is smaller than a Young's modulus of the electrode active material layer.
